(19) United States
(12) Patent Application Publication
(10) Pub. No.: US 2006/0243704 A1
(43) Pub. Date: Nov. 2, 2006

(54) Method and apparatus for arc welding

(75) Inventors: Christoph Matz, Unterschleissheim (DE); Ernst Miklos, Kirchheim (DE); Wolfgang Sapia, Unterschleissheim (DE)

Correspondence Address: CROWELL & MORING LLP;INTELLECTUAL PROPERTY GROUP, P.O. BOX 14300, WASHINGTON, DC, 20044-4300, US

(73) Assignee: Linde Aktiengesellschaft, Wiesbaden (DE)

(21) Appl. No.: 11/395,581

(22) Filed: Mar. 31, 2006

(30) Foreign Application Priority Data
Apr. 1, 2005 (DE) 10 2005 014 969.3

(51) Int. Cl. B23K 9/173

(52) U.S. Cl. 219/74; 219/137 PS

(57) ABSTRACT

A method and apparatus for protective gas welding using at least two consumable electrodes to which at least two different potentials are applied is disclosed. A common weld pool is formed by one leading electrode and at least one trailing electrode. When two electrodes are used, this method is also referred to as tandem welding. A larger electrode diameter is used for the leading electrode in comparison with the trailing electrode. Furthermore, a protective gas mixture consisting of 3 to 40 volume % carbon dioxide and/or oxygen and argon and optionally helium is used.

This application claims the priority of German Patent Document No. 10 2005 014 969.3, filed Apr. 1, 2005, the disclosure of which is incorporated by reference herein.

### BACKGROUND AND SUMMARY OF THE INVENTION

The invention relates to a method for welding, using at least two consumable electrodes to which at least two different potentials are applied, a shared molten weld pool being formed by one leading electrode and at least one trailing electrode. Furthermore, the invention relates to the use of a protective gas mixture for this method.

For arc welding under a protective gas, various welding methods are used. In addition to the method using consumable electrodes, including metal-active gas welding and metal-inert gas welding, other welding methods include tungsten inert gas welding which works with a non-consumable electrode and plasma welding and submerged arc welding. To increase productivity, high-performance welding methods have been used to an increasing extent in recent years. High-performance welding methods, which usually operate with consumable electrodes, are characterized by higher welding powers of the electrodes in comparison with conventional metal-protective gas welding. Either wires having very large wire diameters are used as the electrodes or the wire feed rate is higher than in conventional metal-protective gas welding. The higher deposition rates can be manifested in higher welding speeds or higher welding volumes in comparison with conventional welding. The principles of metal-protective gas high-performance welding are described in detail in the Memorandum of the German Society for Welding and Related Methods, DSV 0909-1 (September 2000) and DSV 0909-2 (June 2003).

In addition to the welding methods that are generally used in conventional welding with a consumable electrode, there are also high-performance welding methods in which two or more electrodes are consumed, so-called multiwire processes. As a rule, two consumable electrodes are used, but three or more electrodes are also possible. The electrodes are fused in separate arcs under a shared protective gas blanket and together with the molten workpiece material, they form a shared molten weld pool. The electrodes are arranged in succession one after the other as seen in the welding direction, so that one leading electrode is followed by one or more trailing electrodes. If two electrodes are used and the same potential is applied to both electrodes, this is called double-wire welding. However, it is called tandem welding if different potentials are applied to the two electrodes. Therefore, two contact tubes, two current sources and two controls are needed for implementation of tandem welding, but the current sources may be coupled and may even be operated in master-slave mode.

In addition to the methods of high-performance welding using two or more wires in which the material of the consumable electrodes is converted to a common molten pool or weld pool, there is also another method for introducing large quantities of filler material for filling the large welding volumes, namely welding in two or more layers. In this method, the filler material is introduced layer by layer beginning with the bottom layer. The bottom layer solidifies before the next layer is welded, so there is no mixing of layers. Welding in multiple layers is normally performed in succession, but it is also possible to guide two or more electrodes jointly over a workpiece, with the electrodes being mounted at such a distance from one another that the weld filler created by the leading electrode has already solidified to the extent that it forms its own weld layer before additional molten filler material is introduced into the weld with the trailing electrode. Welding methods for large welding volumes in layers which are not created in two working steps but instead are created with two successive electrodes are disclosed in Japanese Patent Documents JP6234075, JP63154266 and JP2092464, for example. In addition to the distance between the two electrodes, using a slag forming filler wire ensures the formation of the layer.

In general, all protective gas welding methods have a relatively low fusion penetration in comparison with other welding methods and in particular in comparison with submerged arc welding. This is also true of the multiwire processes. However, the strength of a welded joint depends to a significant extent on the depth and quality of the fusion penetration. In particular when a wide gap must be bridged and large volumes must be filled with weld metal, adequate and uniform filling and a sufficiently deep fusion penetration, which are the prerequisites for good bonding, are often impossible to achieve. A certain influence on the fusion penetration is achieved in metal-protective gas welding through the choice of the composition of the protective gas and the welding speed. In addition to fusion penetration, other factors such as arc stability, sputtering or formation of pores must also be taken into account in the choice of the protective gas, so that fusion penetration can be influenced only to a limited extent through the choice of the protective gas. However, an improvement in fusion penetration, which is achieved by reducing welding speed, is usually undesirable because a reduction in welding speed results in lower productivity. When using two or more wires, the strength and load carrying ability of the weld depend to a significant extent on whether or not a shared molten weld pool is formed. If there is no shared molten weld pool during welding, this is welding in multiple layers, although the layers are being applied very rapidly one after the other. A layer is assigned to each welding wire because the molten weld pools assigned to the individual wires solidify separately from one another and thus there is no blending of filler material. These layers are bonded together, but there is a division of the total weld into layers. This division into layers is also clearly discernible in micrograph sections. The layer design results in overall welds that are often of a much lower quality with regard to strength and load carrying ability than welds which do not show this division into layers and are attributed to only a single molten weld pool.

Therefore, the object of the present invention is to provide a method which results in a sufficiently deep fusion penetration even at high welding speeds, while satisfactorily filling large welding volumes at high welding speeds and at the same time also producing satisfactory weld surfaces and ensuring a high strength and load carrying ability and thus high quality welds.

This object is achieved according to this invention by using a larger electrode diameter for the leading electrode in comparison with the trailing electrode. Due to the fact that a shared molten weld pool is formed in the inventive method, this ensures that the weld will meet the highest demands with regard to strength and load carrying ability. On the other hand, owing to the difference in electrode diameters, it is possible to assign different tasks to the electrodes, so that the requirements of fusion penetration, filling of large welding volumes and satisfactory weld surfaces can be fulfilled in a single welding operation. It has surprisingly been found that although there is a shared molten weld pool in the inventive method, an assignment of tasks to the electrodes is nevertheless possible despite the shared weld pool. On the other hand, mixing of the molten electrode material proceeds to such an extent that a shared weld pool is formed while on the other hand the material introduced first remains at the base of the weld while the filling material added last can be found at the top of the weld. Consequently, it is possible to assign tasks to the leading electrode and the trailing electrode despite the development of a shared weld pool. In the inventive method, the leading electrode is responsible for the fusion penetration and filling of the welding volumes. Since the diameter of the leading electrode can be selected to be relatively large in the inventive method, a very high welding current can be used for the leading electrode. A high welding current in turn ensures a deep fusion penetration so the result is a bonded weld which meets even very high quality demands, in particular with respect to strength. Furthermore, because the diameter of the leading electrode is greater than the diameter of the trailing electrode(s), it is possible to adjust a very high welding performance for the leading electrode, so that very large welding volumes can be filled with weld metal uniformly and without any pores. However, a trailing electrode, in particular the last electrode, is used to form the weld surface. When using two electrodes, the fusion penetration is thus determined by the leading electrode, and the weld surface is formed by the trailing electrode. If three or more electrodes are used, the electrode(s) forming the middle layers contribute mostly toward improving fusion penetration but to some extent also contribute to forming the weld surface. The diameter and fusion performance of the middle electrode(s) are therefore to be selected with regard to these two aspects. Consequently it is possible with the inventive method to select smaller diameters for the trailing electrode(s) in comparison with the leading electrode, these diameters being optimized with regard to the particular function. In particular for the last electrode with which the weld surface is formed, a diameter that ensures optimum properties of the weld surface and with which overheating of the weld surface can be prevented is selected. Because the electrode has a smaller diameter, the parameters for the trailing electrode can now be adjusted so that overheating of the weld surface is prevented. Heavy oxidation of the weld surface and a high surface roughness may thus be suppressed. It is thus possible with the inventive method to adjust the parameters for the leading and trailing electrodes so that they differ so greatly from one another that the contrary requirements with regard to fusion penetration and weld surface can be met in a single operation even at high welding speeds. Therefore the possible applications for high-performance welding with multiwire processes are expanded significantly, in particular the possible applications for tandem welding processes.

In an advantageous embodiment of this invention, different rates of wire advance are used for the leading and trailing electrodes. The rate of wire advance has a great influence on the fusion performance, so that the advantages of the invention can be effectively supported by the choice of the rate of wire advance.

Two electrodes with a distance of 3 to 12 mm, preferably 4 to 10 mm, especially preferably 5 to 7 mm from one another are advantageously used, the distance between the electrodes being measured after adjusting the position of the protective gas nozzle before the welding process by extending the electrodes to the workpiece and the ends of the electrodes coming in contact with the workpiece. These adjustments are recommended for producing a shared weld pool. However, if the value selected for the distance to the electrode ends (usually a value above the specified values) is too high, then separate weld pools will form and the process will consequently become a two-layer welding process. In this advantageous embodiment of the invention, a shared weld pool is thus ensured; furthermore, the leading electrode can fulfill requirements with regard to fusion penetration and welding volumes, while the trailing electrode can fulfill requirements with regard to the weld surface.

In an advantageous embodiment of this invention, the leading electrode has a diameter between 1.0 and 2.0 mm, preferably between 1.2 and 1.6 mm. Deep fusion penetration and filling of large welding volumes can be achieved even at high welding speeds when using electrode diameters of this size. Wire electrodes, in particular solid wire electrodes, are especially suitable for the inventive process.

In addition, the last of the trailing electrodes advantageously has a diameter which is at least 0.1 mm, preferably at least 0.2 mm less than the diameter of the leading electrode. It has been found that at least this difference in diameters is necessary to achieve the advantages of this invention.

The electrodes are advantageously positioned one after the other in the welding direction. For better bridging of gaps or in lap joints, however, it may also be advantageous to rotate the electrodes with respect to the welding direction. In most cases, an angle of 10° to 30° with respect to the welding direction is recommended.

For the inventive method, argon, helium, carbon dioxide, oxygen or a mixture of two or more of these components is used as the protective gas with particular advantage. The advantages of this invention can be achieved especially well with a protective gas consisting of these components.

The protective gas advantageously contains 3 to 40 vol %, preferably 5 to 25 vol %, especially preferably 8 to 20 vol % carbon dioxide. Using carbon dioxide in the protective gas prevents pores from forming and also facilitates outgassing after the welding process. In addition, the carbon dioxide ensures a good heat input into the workpiece. Because of the deep fusion penetration achieved with the inventive method, a good heat input and prevention of pores over the entire area of the fusion zone are necessary to obtain high quality welds. However, a higher carbon dioxide content than that specified above has negative effects on the surface properties of the weld because interfering oxidation processes at the surface become increasingly important with an increase in the carbon dioxide content.

The protective gas advantageously contains 5 to 60 vol %, preferably 10 to 50 vol %, especially preferably 20 to 35 vol % helium. The helium content improves the heat input of the protective gas into the workpiece owing to the high thermal conductivity of helium and therefore also improves the strength and load carrying ability of the weld as a whole. However, if the helium content is too high, it results in instability of the arc which has a negative effect on the quality of the welding process.

The protective gas advantageously contains 1 to 15 vol %, preferably 3 to 10 vol % and especially preferably 3 to 5 vol % oxygen. Oxygen in the protective gas has an effect similar to that of carbon dioxide, but it can be added only in lower amounts than carbon dioxide because of its stronger oxidizing effect.

In addition to the pure gases, two-component mixtures of carbon dioxide and argon, oxygen and argon or helium and argon as well as three-component mixtures of carbon dioxide or oxygen with helium and argon are suitable for the inventive process. Four-component mixtures of carbon dioxide, oxygen, helium and argon may also be used. The volume amounts of the mixtures are advantageously to be selected as given above. The composition of the mixture and the mixing ratio are selected from the standpoint of the given welding task and will depend in particular on the workpiece to be welded and the filler materials used.

An advantageous further embodiment of the present invention works with gas entrainment. The use of gas entrainment means that in addition to the protective gas surrounding the arc and directed at the weld pool, another protective gas stream is also used. This additional protective gas stream is directed at the workpiece with a comparatively weak volume flow and covers the fresh weld. The fresh weld is characterized in that the weld pool has already solidified but has not yet cooled. Using a gas entrainment system thus ensures that the weld will remain under a protective gas even during cooling. The use of a gas entrainment system is advantageous in many cases because a great deal of material is melted from the electrodes and introduced into the weld with the inventive method for filling large welding volumes and therefore cooling of the weld takes a relatively long amount of time.

In an advantageous embodiment of this invention, the leading electrode is operated in the spray arc mode and the last of the trailing electrodes is operated with a pulse technique.

In another advantageous embodiment, the leading and trailing electrodes are operated with the pulse technique.

With the pulse technique, either synchronous and phase-shifted pulses or asynchronous pulses are supplied advantageously with the pulse technique. However, pulses that are synchronous and in-phase are also possible.

The inventive method is advantageously suitable for steels, especially for steels with a greater thickness. It manifests its advantages especially in welding steel containers and especially in producing round welds. This welding job presents requirements that can be met satisfactorily only by the inventive method. However, the inventive method is also very suitable for butt welds and fillet welds. Butt welds and fillet welds for supplying steel in great thicknesses are often used in shipbuilding, so the inventive method also manifests its advantages in this field. It is thus possible with the inventive method to join great wall thicknesses and to do so at a high speed, consistently yielding welds characteristic of a shared weld pool. This method is suitable in particular for joining thick plates with a thickness in the range of 3 mm to 5 mm.

These advantages are manifested in particular in welding gas bottles for compressed or liquefied gases (e.g., propane or butane gas bottles).

Furthermore, the use of a protective gas mixture for tandem welding with two electrodes is also claimed here, whereby the leading electrode has a larger electrode diameter in comparison with the trailing electrode, where the protective gas mixture consists of 3 to 40 vol % carbon dioxide and/or oxygen and argon and optionally helium. The preferred volume amounts for these components correspond to the specifications given above.

### BRIEF DESCRIPTION OF THE DRAWINGS

The present invention is explained in greater detail below with reference to the drawings, in which:

FIG. 1 is a schematic illustration of an exemplary embodiment of the present invention;

FIGS. 2a and 2b illustrate a procedure for determining the distance between the electrodes; and

FIG. 3 shows a micrograph of a weld produced by the present invention.

### DETAILED DESCRIPTION OF THE DRAWINGS

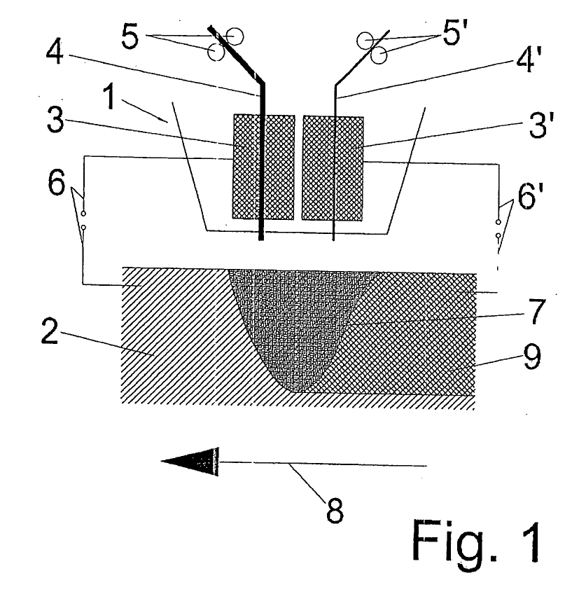

FIG. 1 shows schematically a protective gas nozzle 1 for welding a workpiece 2 which comprises two contact tubes 3 and 3′, two electrodes 4 and 4′ with two wire feed mechanisms 5 and 5′. Furthermore, connections for providing the potentials 6 and 6′ and a shared weld pool 7 are also shown. The welding direction is indicated with the arrow 8 and the weld pool which solidifies to form the weld after the welding operation is labeled as 9.

The protective gas nozzle 1 containing the two consumable electrodes 4 and 4′ is directed at the workpiece 2. Two independent arcs burn between the electrode 4 and the workpiece 2 and between the electrode 4′ and the workpiece 2, both arcs being surrounded by a shared protective gas blanket which is supplied through the protective gas nozzle 1. The two electrodes form a shared weld pool 7 in the workpiece 2. The two independent electrodes 4, 4′ are guided by two separate contact tubes 3 and 3′ which are connected to two different current sources, resulting in two different potentials 6 and 6′ for the electrodes. Furthermore, the two electrodes 4 and 4′ have two independent wire feed mechanisms 5 and 5′. According to this invention, the leading electrode 4 has a larger diameter than the trailing electrode 4′. The two electrodes 4 and 4′ are applied one after the other in the direction of welding. Wire electrodes with a diameter of 1.6 and 1.2 mm are used as the electrodes, for example. For the wire feed mechanisms, values between 5 and 20 m/min are advantageously established. The welding current is set at values between 80 and 500 A, preferably between 100 and 400 A and the welding voltage is set at values between 15 and 50 V, preferably between 20 and 40 V. For the case when a pulsed arc is used, these values are considered averages. It may also be advantageous to use the two electrodes 4 and 4′ in master-slave mode, in which case the leading electrode 4 becomes the leading master. With this choice of parameters, the welding speed is in the range of 50 to 300 cm/min. An especially suitable protective gas mixture here is a mixture of 8 to 25 vol % carbon dioxide and argon in the remaining amount by volume and especially preferably a mixture of 8 to 25 vol % carbon dioxide, 10 to 40 vol % helium and argon in the remaining part by volume. In addition to the two- and three-component mixtures of carbon dioxide, argon and optionally helium which are especially preferred in the aforementioned volume ratios, the three-component mixtures of oxygen, helium and argon are especially advantageous here and here again in turn the mixture of 3 to 5 vol % oxygen, 20 to 30 vol % helium and the remainder being argon is especially preferred. However, the two-component mixtures of carbon dioxide or oxygen and argon, three-component mixture of carbon dioxide, oxygen and argon and four-component mixtures of carbon dioxide, oxygen, helium and argon may also be used. The protective gas mixtures here support the inventive method and result in the advantages of the invention being manifested in a particular manner.

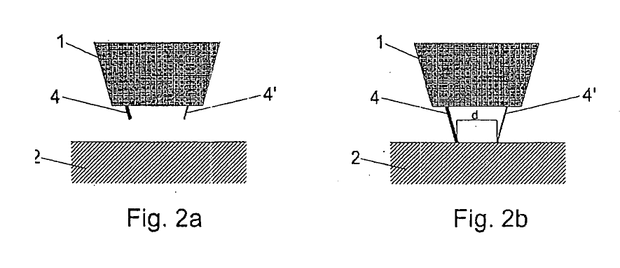

On the basis of FIGS. 2a and 2b, the procedure for determining the distance between the electrodes is explained below. The same reference numbers are used in FIGS. 1 and 2. The protective gas nozzle 1 with the electrodes 4 and 4′ is mounted above the workpiece 2 at the height required for the welding process (see FIG. 2a). Then the electrodes 4 and 4′ are pushed out of the protective gas nozzle by operating the wire feed until the ends of the electrodes come in contact with the workpiece (see FIG. 2b). The distance between the two points where the electrode ends come in contact with the workpiece is the distance d. Now the electrodes are returned to their original position again by operating the wire feed with the protective gas nozzle 1 in a fixed position. Then the welding begins. The distance can be adjusted by displacing the electrodes or, if the electrodes form an angle to one another as illustrated in FIG. 2, the adjustment is made by varying the angle. In the case of parallel electrode guidance as shown in FIG. 1, the distance d is the same at all points and consequently can be measured on the protective gas nozzle even without the workpiece coming in contact with the protective gas nozzle. In advantageous embodiments of the present invention, the distance d is set at 3 to 12 mm, preferably 4 to 10 mm and especially preferably 5 to 7 mm.

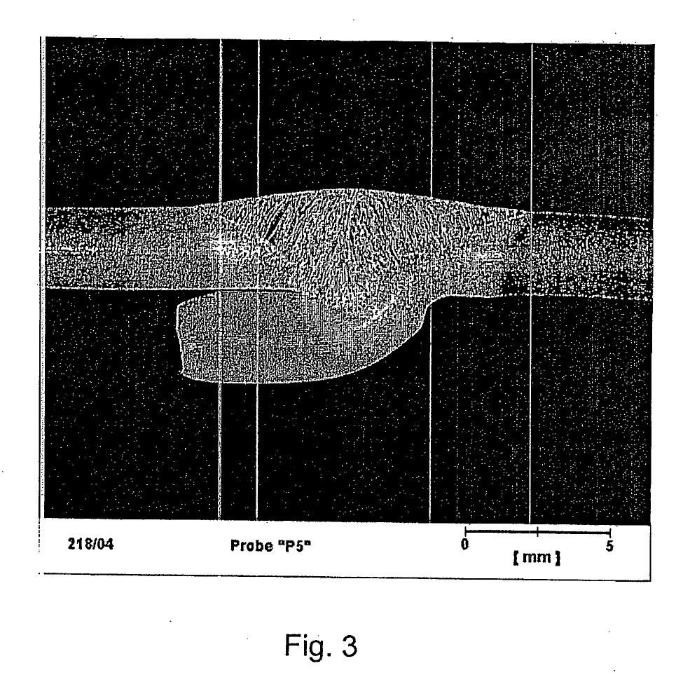

FIG. 3 shows a micrograph of a weld produced by the inventive process. This shows clearly the two plates are pushed one above the other in welding and then have a fold. The micrograph does not show that the weld has been produced by the inventive method because this micrograph is indistinguishable from a micrograph made of a weld produced by a single electrode. Only the deep fusion penetration with the great thickness of the plate is testimony to the fact that this cannot be a traditional weld. The micrograph thus shows clearly that the inventive process is a welding process in which there is only one weld pool.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for welding using at least two consumable electrodes to which at least two different potentials are applied, a common weld pool being formed by one leading electrode and at least one trailing electrode, wherein a larger electrode diameter is used for the leading electrode in comparison with the trailing electrode.

2. The method according to claim 1, wherein different wire feed rates are used for the leading electrode and the trailing electrode.

3. The method according to claim 1, wherein the two electrodes have a distance of 3 to 12 mm between them, the distance between the electrodes being measured before a welding process, performing the measurement on ends of the electrodes that come in contact with a workpiece by adjusting a position of a protective gas nozzle by advancing the electrodes as far as the workpiece.

4. The method according to claim 1, wherein the leading electrode has a diameter between 1.0 mm and 2.0 mm.

5. The method according to claim 1, wherein a last of the trailing electrodes has a diameter which is at least 0.1 mm less than the diameter of the leading electrode.

6. The method according to claim 1, wherein the electrodes are adjusted in succession in a welding direction.

7. The method according to claim 1, wherein a protective gas is argon, helium, carbon dioxide, oxygen or a mixture of two or more of these components.

8. The method according to claim 7, wherein the protective gas contains 3 to 40 volume % carbon dioxide.

9. The method according to claim 7, wherein the protective gas contains 5 to 60 volume % helium.

10. The method according to claim 7, wherein the protective gas contains 1 to 15 volume % oxygen.

11. The method according to claim 1, further comprising gas entrainment of the weld pool.

12. The method according to claim 1, wherein the leading electrode is operated in a spray arc welding mode and a last of the trailing electrodes is operated by a pulse technique.

13. The method according to claim 1, wherein the leading and trailing electrodes are operated by a pulse technique.

14. The method according to claim 13, wherein synchronous and phase-shifted pulses or asynchronous pulses are supplied with the pulse technique.

15. The method according to claim 1, wherein round welds are welded on a steel container.

16. The method according to claim 1, wherein gas bottles are welded.

17. A method for use of a protective gas mixture for tandem welding with two electrodes, a leading electrode having a larger electrode diameter in comparison with a trailing electrode, the protective gas mixture consisting of 3 to 40 volume % carbon dioxide and/or oxygen and argon.

18. A method for welding, comprising the steps of:
applying a different potential to a first consumable electrode and a second consumable electrode, wherein the first consumable electrode is a leading electrode with respect to a welding direction and the second consumable electrode is a trailing electrode with respect to the welding direction, and wherein the leading electrode has a larger diameter than the trailing electrode; and
forming a common weld pool by the leading electrode and the trailing electrode on a workpiece.

19. The method according to claim 19, wherein a molten electrode material from the leading electrode is disposed at a base of the common weld pool and a molten material from the trailing electrode is disposed at a top of the common weld pool.

20. An apparatus for welding, comprising:
a first consumable electrode and a second consumable electrode, wherein the first consumable electrode is a leading electrode with respect to a welding direction and the second consumable electrode is a trailing electrode with respect to the welding direction, wherein the leading electrode has a larger diameter than the trailing electrode, and further wherein a different potential is applied to the leading electrode and the trailing electrode;
the leading electrode and the trailing electrode forming a common weld pool on a workpiece.
